(19) United States
(12) Patent Application Publication
(10) Pub. No.: US 2014/0254873 A1
(43) Pub. Date: Sep. 11, 2014

(54) METHOD AND DEVICE FOR DETECTING INTERFERING OBJECTS IN THE AMBIENT AIR OF A VEHICLE

(71) Applicant: Petko Faber, Renningen (DE)

(72) Inventor: Petko Faber, Renningen (DE)

(73) Assignee: ROBERT BOSCH GmbH, Stuttgart (DE)

(21) Appl. No.: 14/238,657

(22) PCT Filed: Jun. 28, 2012
(86) PCT No.: PCT/EP2012/062576

§ 371 Date: May 29, 2014

(30) Foreign Application Priority Data
Aug. 23, 2011 (DE) 10 2011 081 391.8

(51) Int. Cl. G06K 9/00; B60Q 1/00; B60Q 1/08

(52) U.S. Cl. CPC G06K 9/00805; B60Q 1/085; G06K 9/00798; B60Q 1/0023
USPC 382/103

(57) ABSTRACT

A method for detecting interfering objects in the ambient air of a vehicle, include determining line structures in at least one image section of an image of surroundings of the vehicle, determining a position of a first converging area of first line structures and a position of a second converging area of second line structures, and ascertaining interfering objects depicted in the image which represent objects present in the ambient air of the vehicle, based on the position of the first converging area and the position of the second converging area.

### FIELD OF THE INVENTION

The present invention relates to a method for detecting interfering objects in the ambient air of a vehicle, to a corresponding device, and to a corresponding computer program product.

### BACKGROUND

Rain or falling snow flakes limit the visual range of a driver of a vehicle.

German patent application publication DE 10 2010 030 616 describes a method for detecting an interfering object in at least one camera image of a camera image sequence.

### SUMMARY

The present invention introduces a method for detecting interfering objects in the ambient air of a vehicle, a device which uses this method, and a corresponding computer program product.

The vision of a driver of a vehicle may be impaired by interfering objects present in the air, such as rain drops or snowflakes. A camera of the vehicle may detect the interfering objects. When a vehicle is driving, interfering objects present in the vicinity of the camera move more quickly through an image of the camera due to the short distance thereof from the camera than scene objects such as roadway markings or roadway boundaries which are located farther away from the camera. Since the interfering objects move relative to the camera during the exposure time of an image of the camera, the interfering objects appear as line structures in the image. The line structures resulting from the interfering objects provide an estimation of the vehicle's own movement. The line structures converge in a common focus of expansion. This focus of expansion may be compared to a focus of expansion of lines which identify a course of the roadway on which the vehicle is moving. If the focus of expansion of the line structures resulting from the interfering objects and the focus of expansion of the lines identifying the course of the roadway are in different positions, this indicates the presence of interfering objects. However, if all, or at least a large part, of the lines and line structures present in the image converge in one and the same focus of expansion, which corresponds to the focus of expansion of the course of the roadway, this indicates that no interfering objects are present.

Advantageously, according to an example embodiment, poor weather situations, or limited visibility conditions in general, can also be inferred from the detection of interfering objects. The information about the interfering objects may be used by assistance systems of the vehicle to perform assistance functions such as, for example, night time visibility assistance, alerts regarding the presence of people, adaptive light control, lane departure warning, or traffic sign recognition.

The approach presented here may be combined with other methods for detecting interfering objects. In this way, interfering objects may be reliably detected under various conditions.

Due to the approach presented here, it is also possible, for example, to detect falling snow and rain at night utilizing the vehicle's own active roadway illumination and to make this information available to other assistance systems.

According to an example embodiment of the present invention, a method for detecting interfering objects in the ambient air of a vehicle includes the steps of: determining line structures in at least one image section of an image of surroundings of the vehicle; determining a position of a first converging area of first line structures and a position of a second converging area of second line structures of the majority of line structures; and ascertaining interfering objects depicted in the image which represent objects present in the ambient air of the vehicle, based on the position of the first converging area and the position of the second converging area.

The vehicle may be a passenger car or a truck, for example, which moves on a roadway, for example a street. The interfering objects may be objects present in the air which limit a range of vision of a driver of the vehicle. The interfering objects may be located in particular in the area ahead of the vehicle approximately at or beneath the eye level of the driver. The interfering objects may be, for example, snowflakes, rain drops, whirled up or falling leaves, sand, soil particles, or insects. The interfering objects may hover in the air or move in the air. The image may represent a picture of the surroundings of the vehicle taken by an image recording device situated on the vehicle, for example a camera. The image may depict an area of the surroundings located ahead of the vehicle in the driving direction. The image section may represent a section of the image. The image section may be centered around an optical axis of the image recording device. A line structure can represent a structure in the image section which extends in a main direction. Line structures can be ascertained, for example, with the aid of edge detection in the brightness distributions of the image. A first line structure may be caused by a linear object, for example a roadway marking, in the surroundings of the vehicle. Such a linear object is depicted in the image as a linear structure. A second linear structure may be caused by an interfering object moving transversely to the camera plane during the exposure time of the image. According to an example embodiment, a long exposure time is selected to obtain suitable second line structures. According to an example embodiment, the exposure time is selected as a function of a speed of the vehicle. For example, at a high speed, a shorter exposure time can be selected than at a lower speed. In an example embodiment, a division step is performed in which the line structures are divided into first line structures and second line structures. For example, detected line structures can be compared to stored line structures to divide the line structures into first line structures and second line structures. For example, the first line structures can be detected as such structures with the aid of object detection. A converging area can be a focus of expansion or a limited area in which the associated line structures intersect. The focus of expansion can be ascertained by extending the detected line structures in the image section. Suitable algorithms can be employed for this purpose. The positions of the converging areas may be located within the image section or outside the image section. The position of the converging area of the first line structures may be located at the level of the horizon visible to the driver of the vehicle. If the positions of the converging areas are spaced apart from each other, this indicates the presence of interfering objects depicted in the image. Information about a detected presence may be provided to one or more further systems of the vehicle via a suitable interface.

In an example embodiment, the method includes a step of selecting a depiction of a section in the image which is illuminated by a headlight of the vehicle as the at least one image section. The light of the headlight illuminates both roadway markings and interfering objects. The resulting reflections are easily noticeable in the image. This facilitates the determination of the line structures.

In a division step, those line structures which mark a course of a driving route of the vehicle can be selected as first line structures. The course of the driving route can be discernible by depicted lateral or central roadway markings, by guard rails, curbstones, shoulders, roadside structures, parking vehicles, strings of lights, or the like. By suitably evaluating the image, objects which mark the course of the driving route can be detected. Such an object may already have a line structure. This is the case with a continuous roadway boundary line, for example. Multiple such objects may also be situated in a row and connected to form a line structure. This is possible with an interrupted center line, for example.

In the division step or a further division step, those line structures which do not represent a marking of a course of a driving route of the vehicle can be selected as second line structures. Such line structures may be caused in particular by interfering objects. Due to the movement of the interfering objects, the second line structures may be depicted out of focus. If no interfering objects are present, no corresponding second line structures exist.

In the step of determining the position of the second converging area, in an example embodiment, the converging area in which a majority of the second line structures converge is determined as the second converging area. In this way, line structures may be filtered out which do not mark the course of the roadway and which also are caused by interfering objects.

In the determination step, a further position of a further second converging area of the second line structures can be determined In this case, the step of ascertaining interfering objects depicted in the image can be carried out further based on the further position of the further second converging area. For example, second line structures which originate from different image sections may be assigned to the second converging area and to the further second converging area. It may thus be taken into consideration that interfering objects are deflected around the vehicle or the camera by the air flow and, as a result, change their direction.

In an example embodiment, the method includes a step of providing information about a presence of the interfering objects if the position of the second converging area is above or below the position of the first converging area. Below may be defined by a depicted section of the roadway which is located closest to the vehicle in the image. A minimum distance between the converging areas can be predefined as a further criterion for the presence of the interfering objects. A criterion for the presence of the interfering objects can also be that a connecting line between centers of the converging areas is perpendicular to or at an obtuse angle with respect to a horizontal line in the image.

According to an example embodiment, the information about the presence of the interfering objects may be provided to an interface for a light function of the vehicle. For example, vehicle lighting can be adjusted as a function of the presence or absence of the interfering objects. As an alternative or in addition, the information can be provided to further assistance systems of the vehicle or also as a warning to the driver of the vehicle.

According to an example embodiment of the present invention, a device is configured to perform method steps as described herein to detect interfering objects in the ambient air of a vehicle.

The device can be an electrical device which processes sensor signals and outputs control signals as a function thereof The device can include a hardware and/or software interface.

In the case of a hardware design, the interfaces may, for example, be part of a so-called system ASIC which includes a wide variety of functions of the device. However, it is also possible for the interfaces to be separate integrated circuits, or to be at least partially composed of discrete components. In the case of a software design, the interfaces may be software modules which are present on a microcontroller, for example, in addition to other software modules.

Example embodiments of the present invention are directed to a computer program product that includes program code stored on a machine-readable carrier such as a semiconductor memory, a hard disk memory, or an optical memory, and which is used to carry out the method according to any one or more of the example embodiments described herein, when the program is executed on a computer or a device.

The present invention will be described in greater detail hereafter based on the accompanying drawings by way of example, in which identical or similar reference numerals are used for similarly acting elements shown in the different figures without a repeated description of such elements.

### BRIEF DESCRIPTION OF THE DRAWINGS

FIG. 1 shows a schematic illustration of a vehicle according to an example embodiment of the present invention.

FIG. 2 shows an image of a camera according to an example embodiment of the present invention.

FIG. 3 shows a processed image of a camera according to an example embodiment of the present invention.

FIG. 4 shows a flow chart of an example embodiment of the present invention.

### DETAILED DESCRIPTION

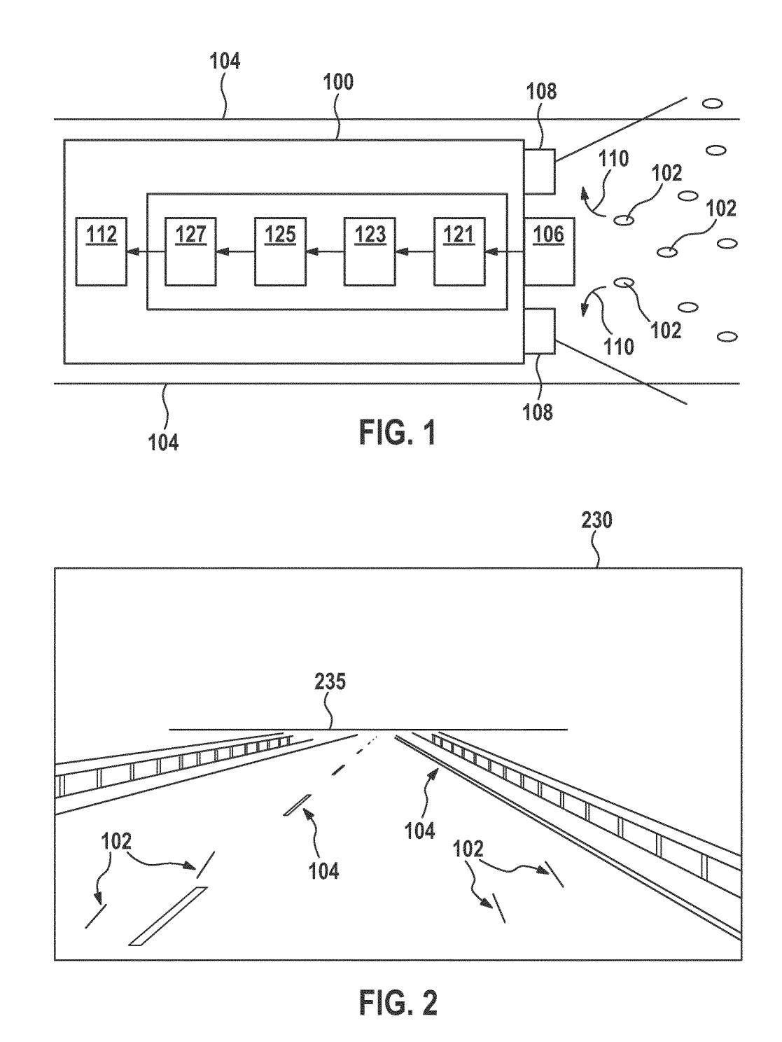

FIG. 1 shows a schematic illustration of a vehicle 100 including a device for detecting interfering objects 102 in the air surrounding vehicle 100, according to an example embodiment of the present invention. Vehicle 100 is shown to be on a roadway which is marked by boundary lines 104. The figure shows multiple interfering objects 102, which according to this example embodiment are snowflakes which here are located ahead of vehicle 100 in the driving direction of vehicle 100, but of which only three are denoted by reference numeral 102. Vehicle 100 includes a camera 106, which is configured to record an image of the area ahead of vehicle 100, in particular an area of the surroundings of vehicle 100 which is illuminated by headlights 108 of the vehicle.

Interfering objects 102 are moving toward the roadway. However, because of the approaching vehicle, interfering objects 102 located close to vehicle 100 carry out an evasive maneuver, as a result of which they are guided around vehicle 100. Interfering objects 102 move similarly to the streamlines in the wind tunnel around vehicle 100. Corresponding evasive maneuvers 110 are indicated by arrows for two of interfering objects 102 by way of example, where one of interfering objects 102 carries out a movement passing to the left of vehicle 100, and the other of interfering objects 102 carries out a movement passing to the right of vehicle 100. Evasive maneuvers 110 of the two interfering objects may take place approximately mirror-invertedly with respect to an optical axis of camera 106. Evasive maneuvers 110 cause interfering objects 102, which are carrying out evasive maneuvers 110, to be depicted in the image of camera 106 not in a punctiform manner, but as line structures.

Vehicle 100 includes a device for detecting interfering objects 102. The device includes an input interface to receive at least one image recorded by camera 106, or image information obtained from such an image, and to determine, based thereon, information about a presence of interfering objects 102. According to the illustrated example embodiment, vehicle 100 includes an assistance system 112, for example for controlling headlights 108. The device is designed to output the information about a presence of interfering objects 102 to assistance system 112 via an output interface.

The device for detecting interfering objects 102 includes a unit 121 for determining line structures in at least one image section of the image of camera 106. Unit 121 is configured to receive and evaluate image information about the image for this purpose. To evaluate the image, for example edge detection, pattern detection or object detection can be carried out to determine the line structures. Unit 121 is configured to output information about the line structures detected in the image to a unit 123 for dividing the line structures into first line structures and second line structures. Unit 123 for division is configured to divide the line structures into different groups. Information regarding the line structures which is provided by a pattern detection or object detection can be used to divide the line structures. A known focus of expansion of the second line structures can also be used for division, so that all the line structures which point in the direction of the known focus of expansion can be defined as second line structures. Unit 123 is configured to output information about the first line structures and the second line structures to a unit 125 for determining focuses of expansion of the line structures. Unit 125 is configured to determine a first converging area of the first line structures and a second converging area of the second line structures. In an example embodiment, if the second converging area is already known, only the first converging area would be determined Unit 125 is also configured to determine positions of the converging areas with respect to each other. Unit 125 is configured to output information about a position of the first converging area and about a position of the second converging area to a unit 127 for ascertaining interfering objects 102 depicted in the image. Unit 127 is configured to ascertain information about a presence of interfering objects 102 based on the positions of the first and second converging areas with respect to each other. According to this example embodiment, unit 127 is configured to output the information about a presence of interfering objects 102 to assistance system 112. Units 121, 123, 125, 127 are part of the device for detecting interfering objects 102 according to the illustrated example embodiment.

Driving in the dark or at dusk and dawn is considered to be one of the particularly stressful driving situations which are subject to above-average risk. Accordingly, to increase traffic safety, it was established by law that the range of headlights 108 of vehicles may be adapted manually or automatically in such a way that other motorists, in particular oncoming and preceding vehicles, are not exposed to glare. While a mechanical adjustment of the range of headlights 108 by the driver due to a changed load is already comparatively imprecise and is frequently underestimated or neglected by the driver, a dynamic adjustment of the range of headlights 108 which is adapted to the instantaneous traffic situation is not implementable by the driver. Here, support for the driver by a corresponding assistance system 112 is advisable.

According to an example embodiment, a video-based assistance system 112 receives information about instantaneously detected interfering objects 102 or information based thereon about instantaneous weather conditions. This assures the functionality of assistance system 112 in so-called poor weather situations such as snowfall or rain.

According to an example embodiment, a corresponding system, for example in the form of the device for detecting interfering objects 102, is designed to provide information about the presence of “poor” weather at darkness on a rough scale, based on the evaluation of the signals of an imaging sensor, for example camera 106, and the comparison to a model-based estimation of the own movement of vehicle 100.

Information on a rough scale about the presence of a poor weather situation, such as snowfall or heavy rain, may, on the one hand, additionally be used to sensitize the driver by acoustic or visual information. On the other hand, such information may be made available to other assistance systems 112.

FIG. 2 shows an image 230 of an area ahead of a vehicle according to an example embodiment of the present invention. Image 230 may have been recorded by camera 106 shown in FIG. 1, for example, and can be evaluated by the described device for detecting interfering objects.

Image 230 shows a section of a road located ahead of the vehicle at darkness. Two lane markings 104 are apparent, which are a dotted center line, on the one hand, and a continuous boundary marking of the road on the other hand. In an area illuminated by a headlight of the vehicle, lane markings 104 have a rectilinear or approximately rectilinear course. Due to the perspective of image 230, it appears as if lane markings 104 converge in the far distance. Despite the movement of the vehicle, the lane markings are sharply depicted. Instead of, or in addition to, lane markings 104, it would also be possible to use the row of posts of a guard rail visible on the right edge of the image or the left boundary marking of the road. Moreover, four line structures resulting from snowflakes 102 are apparent in image 230. Due to the proximity of snowflakes 102 to the camera and the movement of the vehicle, snowflakes 102 are depicted out of focus as lines. The lines of snowflakes 102 have a different longitudinal extension direction than lane markings 104. The line structures in image 320 assigned to lane markings 104 and to snowflakes 102 can be detected and classified by a suitable unit.

FIG. 2 further shows a horizontal line 235 drawn in image 320.

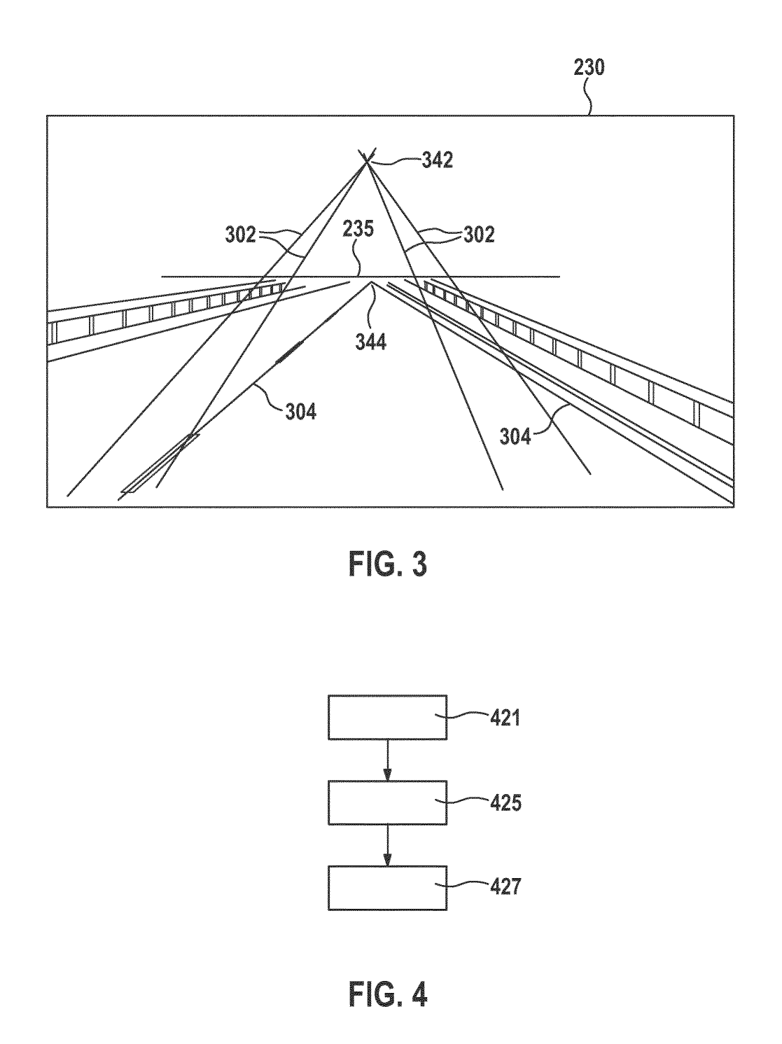

FIG. 3 shows a processed form of image 230 shown in FIG. 2 according to an example embodiment of the present invention. Lines 302, 304 are placed over the detected line structures of the lane markings and snowflakes, the lines extending the detected line structures in the direction of their particular main extension direction. The four lines 302 assigned to the line structures of the four snowflakes have a common focus of expansion 342 or point of intersection. The two lines 304 assigned to the line structures of the lane markings have a common focus of expansion 344. Focus of expansion 344 is located on the level of horizontal line 235. Focus of expansion 342 is located above horizontal line 235. In the vertical direction, focuses of expansion 342, 344 are positioned with no offset or only minor offset from each other. The positioning of focuses of expansion 342, 344 on top of each other indicates the presence of the snowflakes in the range of vision of the camera which recorded image 230.

Based on FIGS. 3 and 4, video-based poor weather detection according to an example embodiment of the present invention will be described hereafter. According to this example embodiment, all line-shaped structures 102, 104 in the range of the area illuminated by the headlight are detected in consecutive video images 230. Having knowledge of focus of expansion 344, all structures that resulted from the light being reflected by a roadway marking 104 can then be identified. If a common focus of expansion 342 is estimated for all remaining line-shaped structures 102 which is located above, or in some circumstances also below, focus of expansion 344 of roadway markings 104 with the aid of regression analysis, then it is highly likely that a weather situation with, e.g., heavy rain or snowfall, exists.

According to an example embodiment, focus of expansion 344 can be estimated. When estimating focus of expansion 344, a distinction can be made between an initial static camera calibration and a dynamic online calibration. With the aid of the online calibration, a necessary correction can be carried out, which is due to temporary loading or also misalignment of the camera, for example. If the natural oscillation of the vehicle, which can be caused, among other things, by the roadway surface, is neglected, this estimation of focus of expansion 344 be sufficient. If higher accuracy is required, in general two options exist for determining focus of expansion 344 more precisely. For this purpose, the vehicle's own movement can be estimated either based on vehicle sensors or by processing information from the video image. In addition, estimated focus of expansion 344 can be subjected to a plausibility check using navigation data which may be available in some circumstances.

According to an example embodiment, the accuracy of the focus of expansion estimated with the aid of an online calibration is sufficient, since, on the one hand, the interfering objects may only be detected, and thus evaluated, in the close range (<50 m), and, on the other hand, qualitative information about the presence of interfering objects is provided.

If the estimation of the focus of expansion based on the roadway marking is temporarily not possible, for example due to other vehicles or a snow-covered roadway, all further assumptions relate to the estimation of the online calibration.

In an example embodiment, a contour is always assumed as the initial model when estimating the focus of expansion based on the roadway marking. Such a contour may be used for both a rectilinear course of the road and for a curve.

Structures which are caused by objects located in the surroundings, such as houses, trees, shrubs or hills, may result in temporary false positives, i.e., unusable focuses of expansion, in the day time. However, since the determination of the presence of interfering objects is not only made in one image, but over a certain time, e.g., over a duration of 45 seconds, these false positives are filtered out over time. At night, in particular in rural areas, there tend to be fewer structures which would temporarily result in false positives.

The exposure time of a video image should rather be selected to be long, e.g., longer than 25 milliseconds. This allows, on the one hand, a preferably long trail of the interfering objects in the video image to be obtained, and, on the other hand, the characteristic features, such as trail length, gradient or brightness, may be detected as optimally as possible. Having knowledge of additional parameters, such as the vehicle's own speed and the light distribution of the headlights, the detectable features allow for a rough estimation of the rate of fall of the interfering objects, via the length of the trail, and the size of the interfering objects, via the width of the trail.

Interfering objects may thus be strongly deflected in the area in front of the camera. This effect must be suitably considered when selecting interfering object candidates for the estimation. When it comes to selecting potential interfering objects, in general it is recommended not to use the objects in the central area ahead of the vehicle, or at a low height with respect to the roadway, since the interfering objects may be subject to turbulence. Moreover, the estimation of a focus of expansion caused by interfering objects should be supported by multiple objects, and this estimation should be constant for a certain time. This supports the attempt to eliminate errors due to infrastructure. Moreover, the sought-after focus of expansion is always to be expected above the focus of expansion of the online calibration, as a function of the vehicle's own speed and the unknown rate of fall of the interfering objects. This applies assuming that no significant peculiarity due to severe weather is present.

FIG. 4 shows a flow chart of a method for detecting interfering objects in the ambient air of a vehicle, according to an example embodiment. For example, the method can be implemented in the device described based on FIG. 1. In a step 421, a determination of line structures in at least one image section of at least one image of surroundings of the vehicle is carried out. The at least one image may be the image shown in FIGS. 2 and 3. In a step 425, a determination is carried out of a position of a first converging area of first line structures and a position of a second converging area of second line structures. In a step 427, an ascertainment of interfering objects depicted in the at least one image is carried out based on the position of the first converging area and the position of the second converging area. In further steps, information about the interfering objects can be further processed to carry out a poor weather detection, for example. According to an example embodiment, for reliability of the determination of the presence of interfering objects, a majority of images are evaluated according to the method. For example, multiple consecutively ascertained images of a camera are evaluated within a time period which may range between half a minute and one minute, for example, and the information about the interfering objects can be determined based on the evaluation of the majority of images. For this purpose, all method steps can be carried out for each image, and the individual results regarding the presence of interfering objects ascertained therefrom can subsequently be summarized to form an end result. Alternatively, it is also possible to carry out only individual method steps for each of the images, for example to reliably determine the positions of the first, second, or both converging areas. For example, the presence of the interfering objects can be ascertained based on the converging areas which are ascertained over multiple images.

The described example embodiments shown in the figures are selected only by way of example. Different example embodiments may be combined with each other completely or with respect to individual features. It is also possible to supplement one described example embodiment with features of another described example embodiment. Moreover, method steps according to the present invention can be carried out repeatedly and in a different order than described.

1-10. (canceled)

11. A method for detecting interfering objects in ambient air of surroundings of a vehicle, the method comprising:
identifying, by a processing circuit, line structures in at least one image section of an image of the surroundings of the vehicle;
determining, by the processing circuit, a position of a first converging area of a first subset of the identified line structures and a position of a second converging area of second subset of the identified line structures; and
based on the position of the first converging area and the position of the second converging area, ascertaining, by the processing circuit, interfering objects depicted in the image which represent the interfering objects in the ambient air.

12. The method as recited in claim 11, further comprising selecting an area in the image which is illuminated by a headlight of the vehicle as the at least one image section.

13. The method as recited in claim 11, further comprising selecting those of the identified line structures which mark a course of a driving route of the vehicle as the first subset.

14. The method as recited in claim 13, further comprising selecting those of the identified line structures which do not mark the course of the driving route of the vehicle as the second subset.

15. The method as recited in claim 13, further comprising:
selecting a first group of those of the identified line structures which do not mark the course of the driving route of the vehicle as the second subset;
selecting a second group of those of the identified line structures which do not mark the course of the driving route of the vehicle as a third subset of the identified line structure; and
determining a position of a third converging area of the third subset of the identified line structures, wherein the ascertainment of the interfering objects depicted in the image is further based on the position of the third converging area.

16. The method as recited in claim 11, further comprising selecting those of the identified line structures which do not mark a course of a driving route of the vehicle as the second subset.

17. The method as recited in claim 11, wherein an area in which a majority of the line structures of the second subset converge is determined as the second converging area.

18. The method as recited in claim 11, further comprising determining a position of a third converging area of a third subset of the identified line structures, wherein the ascertainment of the interfering objects depicted in the image is further based on the position of the third converging area.

19. The method as recited in claim 11, further comprising forwarding information about a presence of the interfering objects in the ambient air responsive to determining that the position of the second converging area is above or below the position of the first converging area.

20. The method as recited in claim 19, wherein the information is forwarded to an interface of a circuit configured to control a light function of the vehicle.

21. A device for detecting interfering objects in ambient air of surroundings of a vehicle, the device comprising:
a processing circuit configured to:
identify line structures in at least one image section of an image of the surroundings of the vehicle;
determine a position of a first converging area of a first subset of the identified line structures and a position of a second converging area of second subset of the identified line structures; and
based on the position of the first converging area and the position of the second converging area, ascertain interfering objects depicted in the image which represent the interfering objects in the ambient air.

22. A non-transitory computer-readable medium on which are stored instructions that are executable by a processor and that, when executed by the processor, cause the processor to perform a method for detecting interfering objects in ambient air of surroundings of a vehicle, the method comprising:
identifying line structures in at least one image section of an image of the surroundings of the vehicle;
determining a position of a first converging area of a first subset of the identified line structures and a position of a second converging area of second subset of the identified line structures; and
based on the position of the first converging area and the position of the second converging area, ascertaining interfering objects depicted in the image which represent the interfering objects in the ambient air.
